(19) United States
(12) Patent Application Publication
(10) Pub. No.: US 2018/0345422 A1
(43) Pub. Date: Dec. 6, 2018

(54) PLASMA ARC CUTTING GUIDE

(71) Applicant: Steven Allan Hendricks, Dunbar, WI (US)

(72) Inventor: Steven Allan Hendricks, Dunbar, WI (US)

(21) Appl. No.: 15/609,832

(22) Filed: May 31, 2017

(51) Int. Cl. B23K 37/02; B23K 10/00

(52) U.S. Cl. CPC B23K 37/0217; B23K 37/0264; B23K 10/00

(57) ABSTRACT

A plasma arc cutting guide. The guide includes a tube. The tube is an elongated hollow body. The tube includes a first end opposite a second end. A plurality of magnetic spheres are disposed within the tube. A plurality of non-magnetic spheres are disposed within the tube in between the plurality of magnetic spheres.

### BACKGROUND OF THE INVENTION

The present invention relates to plasma arc cutting and, more particularly, to a plasma arc cutting guide.

Manual Plasma Arc Cutting (PAC) uses an electric arc of superheated, electrically ionized gas (plasma) discharged from a hand-held wand, which melts target material just below the wand's ceramic cup, while simultaneously blowing said molten material away from the parent material using a compressed gas delivered through the wand handle.

Maintaining an ideal stand-off (the distance from the wand's electrode to the target material) while advancing through target material is essential for the ideal operation of the PAC. This distance depends on several variables, and is one of the more difficult aspects of hand held PAC's to control. Compounding the difficulty of this manually controlled aspect is following a precise path for the desired cut.

Commercially available guide models rely on thin rubber strips impregnated with mildly magnetic material. These have limited range of shape and holding ability, and they do not assist the operator in maintaining the ideal stand-off.

As can be seen, there is a need for an improved guide used for plasma arc cutting.

### SUMMARY OF THE INVENTION

In one aspect of the present invention, a plasma arc cutting guide comprises: a tube comprising an elongated hollow body having a first end opposite a second end; a plurality of magnetic spheres disposed within the tube; and a plurality of non-magnetic spheres disposed within the tube in between the plurality of magnetic spheres.

In another aspect of the present invention, a plasma arc cutting guide comprises: a tube comprising an elongated hollow body having a first end opposite a second end, wherein the first end defines a first opening leading into the tube and the second end defines a second opening leading into the tube; a plurality of magnetic spheres disposed within the tube; a plurality of non-magnetic spheres disposed within the tube, wherein each of the plurality of magnetic spheres are separated by two of the plurality of non-magnetic spheres; and a first end cap secured to the first end and covering the first opening of the tube and a second end cap secured to the second end and covering the second opening of tube.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a section view of the present invention taken along line 2-2 in FIG. 1;

FIG. 3 is a section view of the present invention taken along line 3-3 in FIG. 1;

FIG. 4 is a section detail view of an embodiment of the present invention; FIG. 5 is a section detail view of an embodiment of the present invention;

FIG. 6 is an exploded detail view of an embodiment of the present invention;

FIG. 7 is a detail perspective view of an embodiment of the present invention;

FIG. 8 is a section view of the present invention taken along line 8-8 in FIG. 7; and

FIG. 9 is a perspective detail view of an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a flexible bendable guide for hand-held plasma arc cutting devices. The present invention delineates a continuous series of curves, straight lines, or other combinations of geometric shapes established by the user and features internally contained magnets which provide firm anchoring to a ferro-magnetic surface. The magnets within the guides tube or sheath hold firmly to the target material, while automatically elevating the wand to an optimal stand-off distance. Combined, the present invention provides for a firm, fixed margin the wand follows along the desired cut path and a consistently fixed stand-off distance.

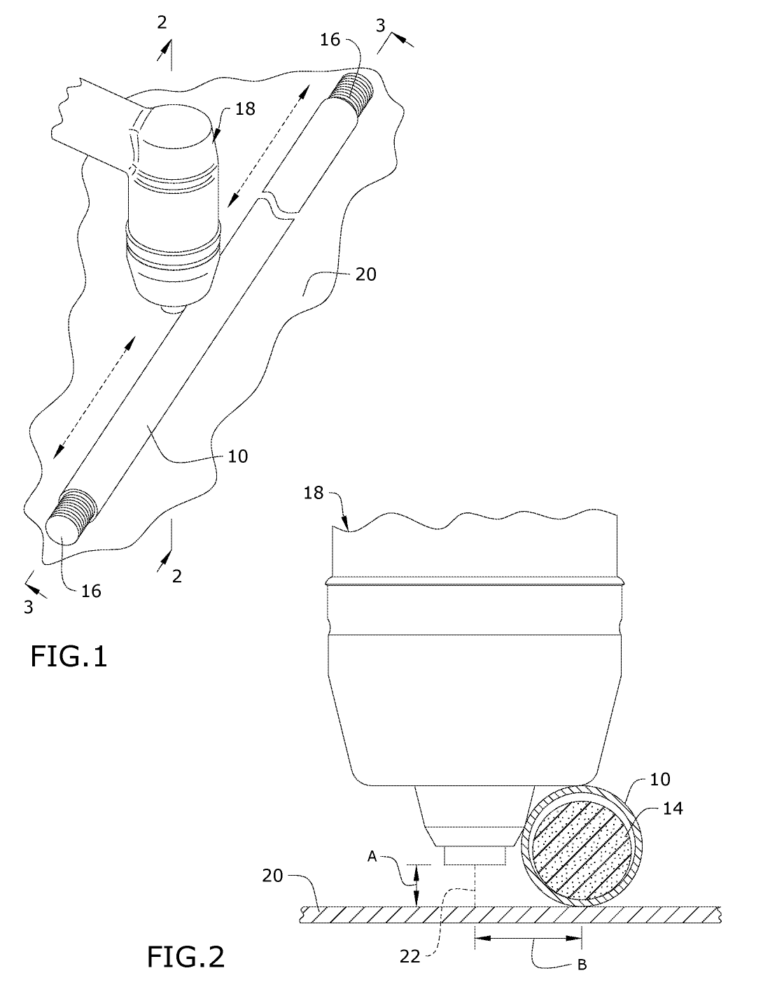

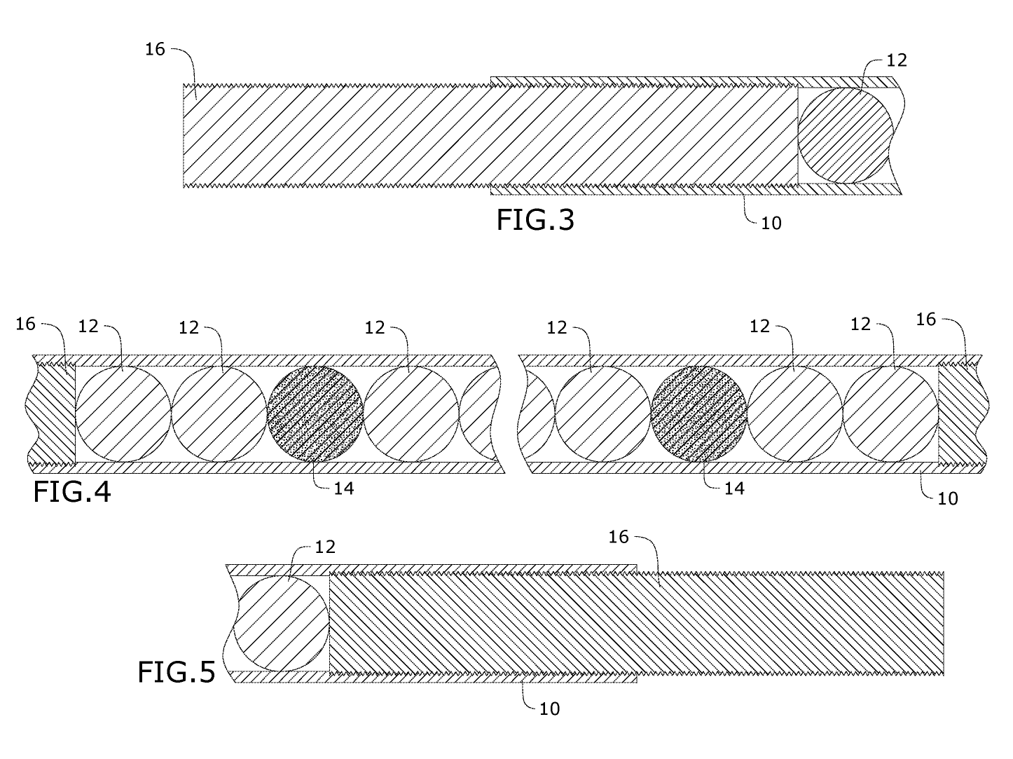

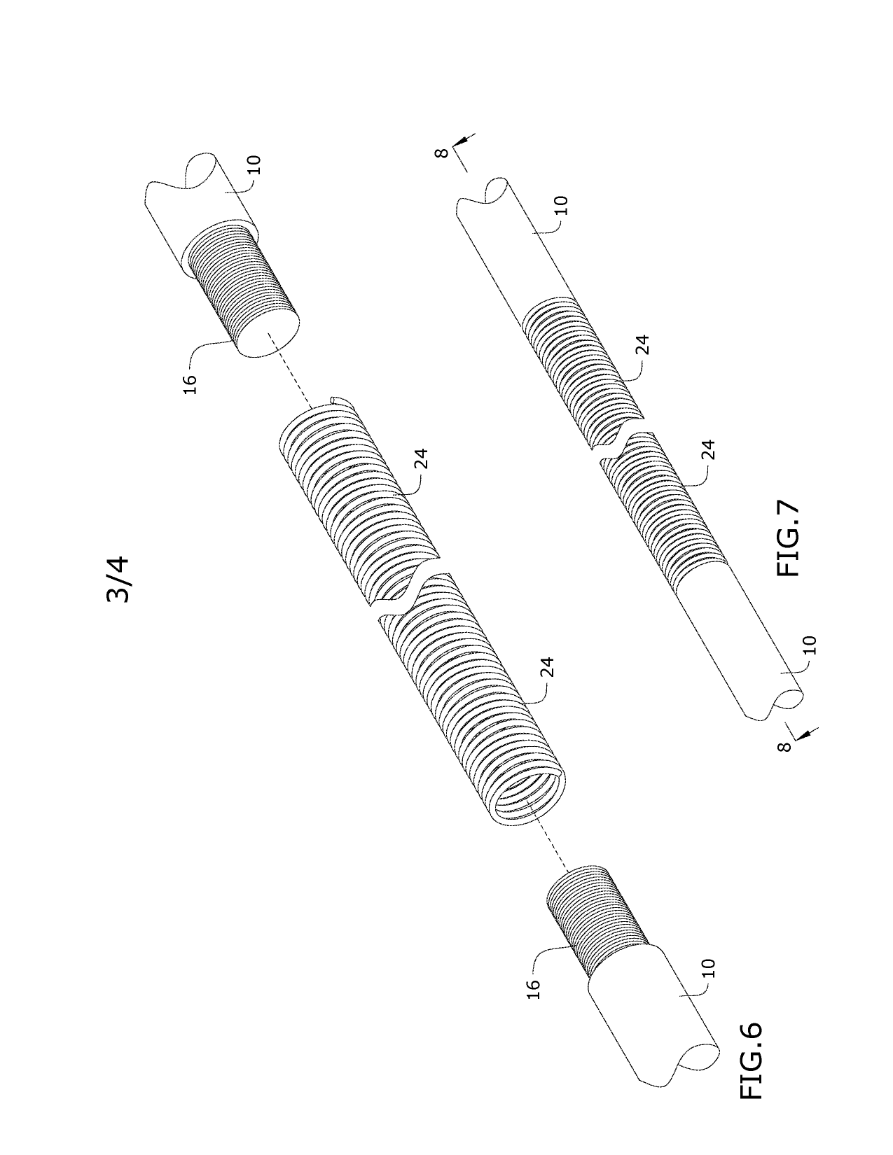

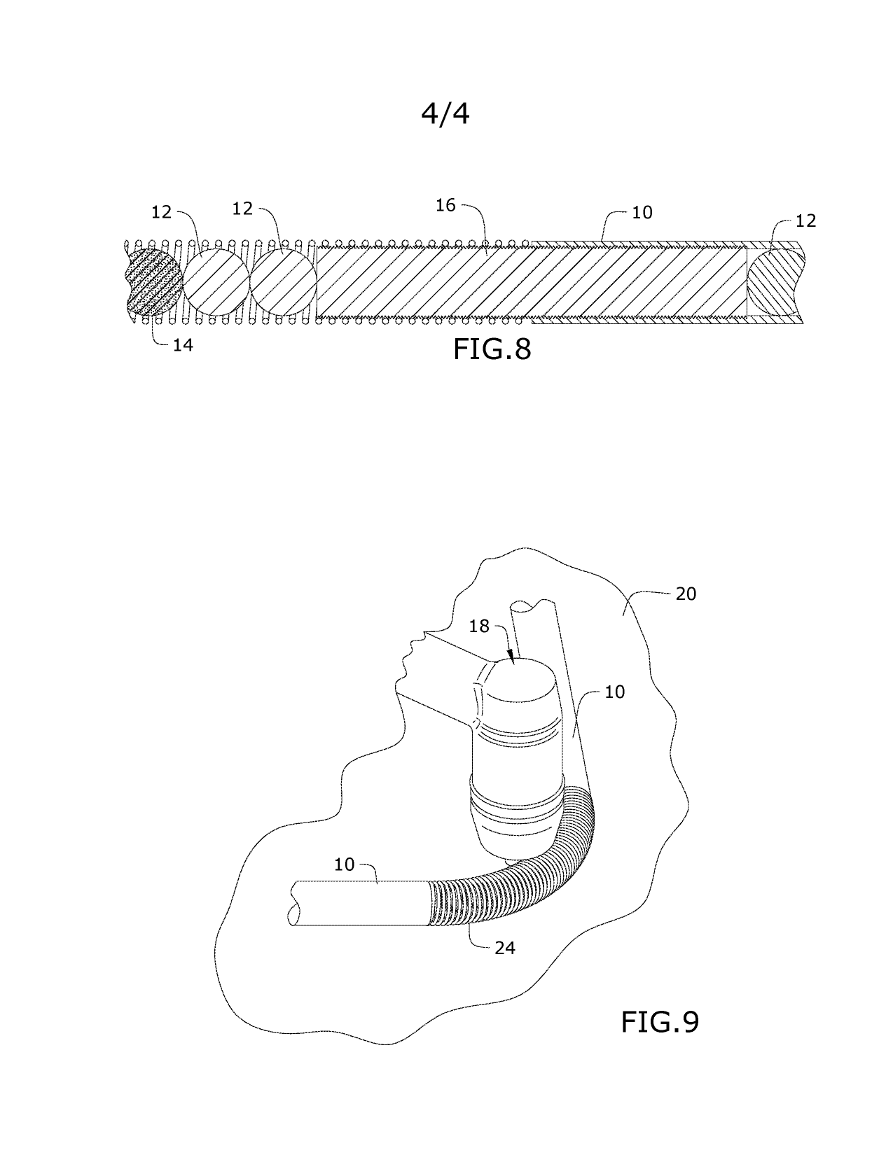

Referring to FIGS. 1 through 9, the present invention includes a plasma arc cutting guide. The guide includes a tube 10. The tube 10 is an elongated hollow body and may be cylindrical in shape. The tube 10 includes a first end opposite a second end. A plurality of magnetic spheres 14 are disposed within the tube 10. A plurality of non-magnetic spheres 12 are disposed within the tube 10 in between the plurality of magnetic spheres 14.

The tube 10 of the present invention may be a flexible and bendable tube. For example, the tube 10 may be made of a soft copper, annealed cooper and the like. An example of a tube 10 that may be used is a soft copper tubing having about a ⅜ inch diameter and about a 0.27 inch internal diameter. The first end of the tube 10 defines a first opening leading into the tube 10 and the second end of the tube 10 defines a second opening leading into the tube 10.

As mentioned above, the present invention includes a plurality of magnetic spheres 14 and a plurality of non-magnetic spheres 12. The non-magnetic spheres 12 separate the magnetic spheres 14 from one another. In certain embodiments, the magnetic spheres 14 and the non-magnetic spheres 12 may alternate in order. Alternatively, two, three or more of the non-magnetic spheres 12 may separate each of the magnetic spheres 14. In certain embodiments, the magnetic spheres 12 may include about a 0.25 inch diameter and the magnetic material forming the spheres 12 may be NdFeB (Neodymium-Iron-Boron). The plurality of non-magnetic spheres 12 may also include about a 0.25 inch diameter and may be made of stainless steel. For example, the stainless steel sphered 12 may be 302 SS* which provides (among other properties) resistance to deformation, high melting temp, and low magnetic properties.

The present invention may further include end caps 16. The end caps 16 may include a first end cap 16 secured to the first end of the tube 10 and covering the first opening and a second end cap 16 secured to the second end of the tube 10 and covering the second opening. In certain embodiments, the first end and the second end each include a threaded female portion. In such embodiments, the first end cap 16 and the second end cap 16 each include a threaded male portion mechanically fastened to the threaded female portion. The end caps 16 may be about 2 inches in length and cut from a length of threaded stock. A portion of the first end cap 16 and the second end cap 16 may extend outside of tube 10.

The present invention may further include a wire coil 24, such as a coil spring. Wire coils 24 may be used to connect two or more plasma arc guides together. The wire coils 24 may each include a first end and a second end. The first end is disposed over a first end cap 16 of a first plasma arc guide and the second end is disposed over a second end cap 16 of a second plasma arc guide, thereby adjoining the plasma arc guides together. The portion of the end caps 16 extending outside of the tube 10 may be threaded, thereby retaining the wire coil 24 to the caps 16. In certain embodiments, a plurality of magnetic spheres 14 and non-magnetic spheres 12 are disposed within the wire coil 24 in the same alternating pattern as within the tube 10.

The simplicity of the components and their arrangements create a fool-proof method to assist operators in establishing and following a smooth continuous guide for the accurate placement of a plasma stream 22 from a plasma torch 18 to a metallic surface 20. When placed against a ferro-magnetic surface, the internal magnetic spheres 14 automatically align themselves to that surface, and provide an exceptionally strong hold. This characteristic allows the operator to contact the torch 18 against the tube 10, and the shape of the ceramic cone of the torch 18 automatically raises the torch 18 to the ideal height above the metallic surface 20. No external holding mechanisms are required to secure the device.

Provided the operator applies continuous light pressure against the device (45° inward), the torch 18 or wand can be advanced along the margin of the tube 10 at an optimal speed without any breaks, gouges, divergent cuts, or other missteps, for the length of the device, giving an exceptionally smooth, uniform and accurate cut.

The repairable/readily available soft copper tubing or sheath provides a mechanism that retains the internal sphere groups; is removable so it can be migrated to another target and still retain its shape, or be rapidly reshaped for an entirely different job; is flexible in 3 dimensions; is heat resistant to minimize the chance of overheating the internal magnetic spheres beyond the operational temperature; is anneal-able so it can be re-softened when necessary, or cheaply replaced which may be performed by the operator with minimum effort to migrate the internal components. The tube end-caps may be threaded rod. These retain the internal components, plus provide a means of seamlessly attaching one or more devices in line, for extending the operational length of the described device.

A method of using the present invention may include the following. The device can be manipulated to form a desired guide pattern using one of several methods, either: 1) Configured manually to follow a jig; 2) Bent to follow a scribed line either on the target material; 3) Follow a drafted blueprint or pattern; and 4) A combination of the above procedures. Once the desired pattern is obtained, the device is lightly clapped against the target material. This assures the internal magnets have aligned themselves with the ferro-magnetic target material which will provide the necessary holding action. The guide is then slid away from the actual cut line desired (approximately ¼ inch) to compensate for the offset of the wand's arc impact spot after the wand has reached its home position. The wand is then butted against the device, and raised slightly to allow the ceramic cone to ride up the curved surface of the sheath. This action assures the operator that the correct “stand-off” of the electrode from the target material. Cutting ensues, using common, good PAC techniques. Light pressure on the wand (both laterally against the sheath body, and downward once the cone has completed its movement to the upper sheath margin) is maintained for the duration of the desired cut. This constant pressure against the sheath during the cut assures the operator that 1) the predetermined cut path is being followed; and 2) the optimal “stand-off” is maintained throughout the length of the cut, even when the wand itself cannot be seen. Individual offset distances should be determined before commencing any cuts. Because manufactures ceramic cones, wand configurations, and other unknowable variables can vary widely, ¼ inch is a general approximation only.

It should be understood, of course, that the foregoing relates to exemplary embodiments of the invention and that modifications may be made without departing from the spirit and scope of the invention as set forth in the following claims.

What is claimed is:

1. A plasma arc cutting guide comprising:
a tube comprising an elongated hollow body having a first end opposite a second end;
a plurality of magnetic spheres disposed within the tube; and
a plurality of non-magnetic spheres disposed within the tube in between the plurality of magnetic spheres.

2. The plasma arc guide of claim 1, wherein the first end defines a first opening leading into the tube and the second end defines a second opening leading into the tube.

3. The plasma arc guide of claim 2, further comprising a first end cap secured to the first end and covering the first opening of the tube and a second end cap secured to the second end and covering the second opening of tube.

4. The plasma arc guide of claim 3, wherein the first end and the second end each comprise a threaded female portion and the first end cap and the second end cap each comprise a threaded male portion mechanically fastened to the threaded female portion.

5. The plasma arc guide of claim 4, wherein a portion of the first end cap and the second end cap extend outside of tube.

6. The plasma arc guide of claim 5, wherein the portions of the first end cap and the second end cap extending outside of the tube are part of the threaded male portion.

7. A wire coil comprising a first end and a second end, wherein the first end is disposed over the first end cap of the plasma arc guide of claim 5 and the second end is disposed over a second end cap of a second plasma arc guide, thereby adjoining the plasma arc guide with the second plasma arc guide.

8. The wire coil of claim 7, further comprising a second plurality of magnetic spheres disposed within the wire coil and a second plurality of non-magnetic spheres disposed within the wire coil in between the plurality of magnetic spheres.

9. The plasma arc guide of claim 1, wherein each of the plurality of magnetic spheres are separated by two of the plurality of non-magnetic spheres.

10. A plasma arc cutting guide comprising:
a tube comprising an elongated hollow body having a first end opposite a second end, wherein the first end defines a first opening leading into the tube and the second end defines a second opening leading into the tube;
a plurality of magnetic spheres disposed within the tube;
a plurality of non-magnetic spheres disposed within the tube, wherein each of the plurality of magnetic spheres are separated by two of the plurality of non-magnetic spheres; and
a first end cap secured to the first end and covering the first opening of the tube and a second end cap secured to the second end and covering the second opening of tube.
